(19) United States
(12) Patent Application Publication
(10) Pub. No.: US 2015/0198245 A1
(43) Pub. Date: Jul. 16, 2015

(54) Hydraulic Drive System

(71) Applicant: Caterpillar Paving Products Inc., Brooklyn Park, MN (US)

(72) Inventors: Michael W. Ries, Coon Rapids, MN (US); Paul A. Dvorak, Hanna City, IL (US); Sudarshan Maiyur, Cary, NC (US)

(21) Appl. No.: 14/153,828

(22) Filed: Jan. 13, 2014

(51) Int. Cl. F16H 61/475

(52) U.S. Cl. CPC F16H 61/475

(57) ABSTRACT

A drive system includes a continuously variable displacement pump and a motor hydraulically driven by the pump. A controller is configured to determine a motor displacement command to shift the motor from a first displacement to a second displacement, and a pump displacement command to change the displacement of the pump. The controller further coordinates transmittal of the pump displacement command and the motor displacement command to maintain the travel speed of the machine while changing the displacement of the pump and shifting the motor from the first motor displacement to the second motor displacement.

### TECHNICAL FIELD

The present disclosure is directed to a machine drive system, and more particularly, to a drive system having a hydraulic transmission with a variable displacement pump and a motor with at least two speeds.

### BACKGROUND

Machines such as wheeled compactors, loaders, trucks, and other machines are used to perform many tasks. To effectively perform these tasks, the machines require an engine that provides a significant amount of torque through a transmission to one or more ground engaging traction devices. Such machines often include conventional manual or automatic transmissions having a discrete number of step-changed output ratios (gears) to control the speed and torque of the ground engaging devices. The output ratios correspond to travel speed ranges, with each having a predefined maximum travel speed.

In some instances, conventional manual and automatic transmissions may be replaced by hydrostatic transmissions that provide an infinitely variable torque-to-speed output ratio within its overall range. This is accomplished by pairing a variable displacement pump and a fixed or a variable-displacement motor. In some systems, the displacement of the motor must be set prior to beginning operation of the machine. In other systems, the displacement may be changed during operation but such change may result in momentary acceleration or deceleration of the machine.

U.S. Pat. No. 7,373,776 discloses a hydrostatic transmission having a variable-displacement pump paired with a fixed-displacement motor. The system includes a shift lever that provides operator input regarding travel direction and selection of a particular transmission gear ratio, a throttle pedal that provides operator input regarding a desired engine speed, and a clutch that provides for a temporary reduction in the transmission gear ratio. A controller receives information from the shift lever, the throttle pedal, and the clutch, and responsively generates control signals that set the displacement of the pump to a fixed value and regulates engine speed, while ensuring that a resulting speed of the motor remains less than a known maximum speed limit.

The foregoing background discussion is intended solely to aid the reader. It is not intended to limit the innovations described herein, nor to limit or expand the prior art discussed. Thus, the foregoing discussion should not be taken to indicate that any particular element of a prior system is unsuitable for use with the innovations described herein, nor is it intended to indicate that any element is essential in implementing the innovations described herein. The implementations and application of the innovations described herein are defined by the appended claims.

### SUMMARY

In one aspect, a drive system for a machine includes a prime mover, a continuously variable displacement pump driven by the prime mover, and a motor hydraulically driven by the pump. The motor has a changeable displacement between a first motor displacement and a second motor displacement. A controller is configured to determine a travel speed of the machine and determine a motor displacement command to shift the motor from the first motor displacement to the second motor displacement. The controller is further configured to determine a pump displacement command to change the displacement of the pump and coordinate transmittal of the pump displacement command and the motor displacement command to maintain the travel speed of the machine while changing the displacement of the pump and shifting the motor from the first motor displacement to the second motor displacement.

In another aspect, a controller-implemented method of driving a machine includes determining a travel speed of the machine, driving a continuously variable displacement pump with a prime mover, and determining a pump displacement command to change a displacement of the pump. The method further includes hydraulically driving a fixed displacement multi-speed motor with the pump, determining a motor displacement command to shift the motor from a first motor displacement to a second motor displacement, and coordinating transmittal of the pump displacement command and the motor displacement command to maintain the travel speed of the machine while changing the displacement of the pump and shifting the motor from the first motor displacement to the second motor displacement.

In still another aspect, a machine includes a prime mover, a continuously variable displacement pump driven by the prime mover, and a motor hydraulically driven by the pump. The motor has a changeable displacement between a first motor displacement and a second motor displacement. A plurality of traction devices are operatively driven by the motor. A controller is configured to determine a travel speed of the machine and determine a motor displacement command to shift the motor from the first motor displacement to the second motor displacement. The controller is further configured to determine a pump displacement command to change the displacement of the pump and coordinate transmittal of the pump displacement command and the motor displacement command to maintain the travel speed of the machine while changing the displacement of the pump and shifting the motor from the first motor displacement to the second motor displacement.

### BRIEF DESCRIPTION OF THE DRAWINGS

FIG. 1 is a perspective view of a machine incorporating the concepts of the disclosure herein;

FIG. 2 is a diagrammatic illustration of an exemplary disclosed drive system and an operator station for use with the machine of FIG. 1; and

FIG. 3 is a flowchart of a process for operating the drive system of FIG. 2 in response to signals received from the operator station.

### DETAILED DESCRIPTION

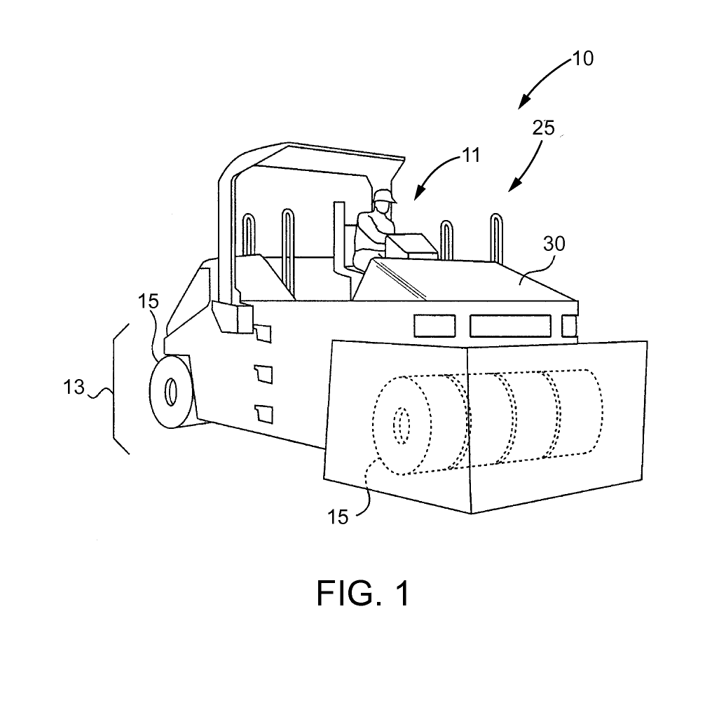

FIG. 1 illustrates an exemplary machine 10 having multiple systems and components that cooperate to accomplish a task. The tasks performed by machine 10 may be associated with a particular industry such as paving, mining, construction, farming, transportation, or another industry known in the art. For example, machine 10 may embody a mobile machine such as the wheeled compactor depicted in FIG. 1, an on- or off-highway haul truck, a loader, or any other type of mobile machine known in the art. Machine 10 may include an operator station 11, from which an operator may control the machine 10. Machine 10 may also include a drive system 13 operatively connected to one or more driven and/or steerable traction devices 15, such as, for example, wheels, tracks, or belts located on each side of machine 10.

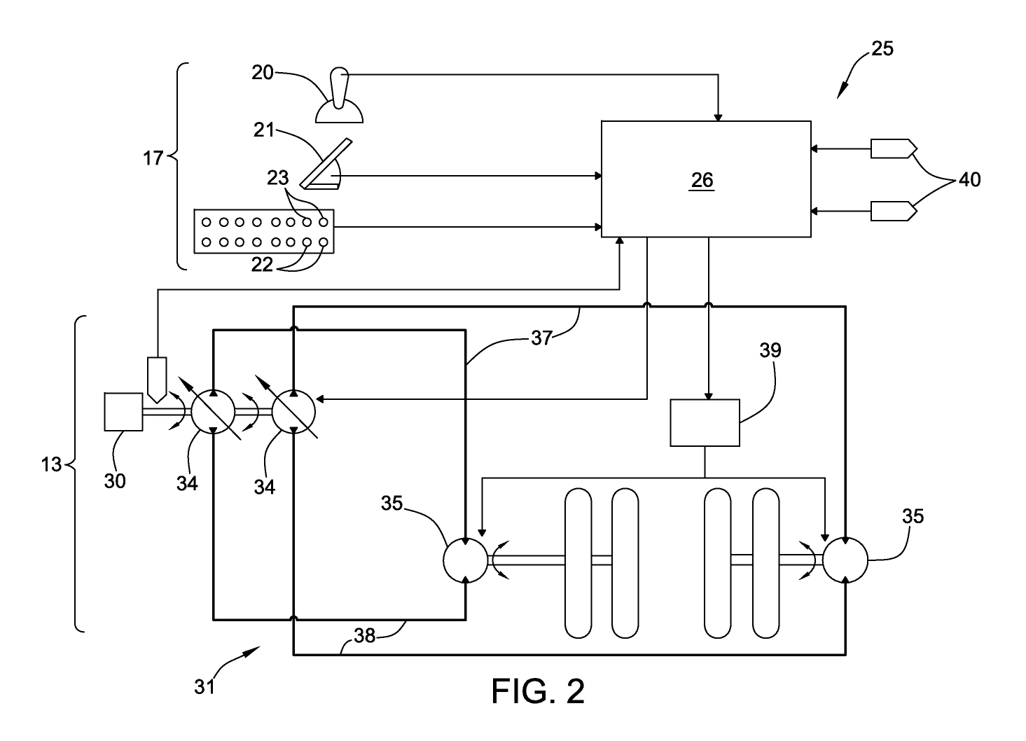

As illustrated in FIG. 2, operator station 11 may include an operator interface 17 proximate an operator seat (not shown) for generating machine command signals indicative of desired machine maneuvers and/or functions in response to operator input. Operator interface 17 may include a plurality of input devices including a throttle input 20, a brake input 21, a transmission input 22, and a speed input 23. Additional operator input devices may be included, if desired. Each input device may take the form of a joystick, pedal, a push-button, a knob, a switch, or another device. The operator may manipulate the input device to affect corresponding operations of machine 10.

Throttle input 20 is depicted as a joystick that is tiltable through a range from a neutral position to one or more maximum displacement positions to generate one or more corresponding throttle input signals that are indicative of a desired percentage of the maximum speed of the machine in particular directions. As described below, the machine 10 may be configured so that the maximum speed of the machine may be set or adjusted by an operator or other personnel. Throttle input 20 may be tiltable from the neutral position to a maximum displaced position in a first direction (e.g. forward) to generate a corresponding first throttle signal. Likewise, throttle input 20 may be tiltable from the neutral position to a maximum displaced position in a second direction (e.g., rearward) to generate a second throttle signal. Values of the first and second throttle signals may correspond to desired percentages of the maximum speed setting for the machine in the forward and reverse directions of travel of the machine, respectively. In other words, the displacement of the throttle input 20 may be directly proportional to the percentage of the maximum speed of the machine based upon a setting or command from an operator or other personnel or as otherwise set within the machine 10.

Brake input 21 is depicted as a foot pedal that is pivotable through a range from a neutral position to a maximum displaced position to generate one or more corresponding displacement signals indicative of a desire to decelerate or reduce the acceleration of machine 10. The displacement signals generated by brake input 21 may be used to slow the machine 10 either by reducing the throttle input command from throttle input 20, by applying service brakes (not shown), or by a combination of the two.

Transmission input 22 and speed input 23 may be used by an operator to select different modes of operation. Specifically, transmission input 22 may be a touch pad having a plurality of push buttons that, when pressed by the operator of machine 10, select one of any number of available transmission control settings (i.e., virtual gears or portions of a continuous range of transmission speed-to-torque ratios). For example, the operator may press a first of the push buttons to select a first gear, in which drive system 13 may operate within a highest torque output range and a corresponding lowest travel speed range. Likewise, the operator may press a second of the push buttons to select a second or higher gear, in which drive system 13 may operate with a lower torque output range and a corresponding higher travel speed range.

Speed input 23 may also be a touch pad having a plurality of push buttons that, when pressed by the operator of machine 10, select one of any number of maximum allowable speeds or available machine travel speed limits that correspond to the maximum displaced position of throttle input 20. For example, if the actual maximum travel speed of the machine is 19 kilometers per hour, each of the push buttons may set a reduced maximum travel speed at some speed less than 19 kilometer per hour. Other manners of setting maximum speeds of machine 10 are contemplated. For example, setting the transmission input 22 to first gear will have the affect of limiting the maximum speed to a number less than the maximum travel speed of the machine 10 when using two gears.

Machine 10 may include a control system 25 as shown generally by an arrow in FIG. 1 indicating association with the machine 10. The control system 25 may be operatively connected to the various input devices to control the machine 10 and one or more sensors to provide data and input signals representative of various operating parameters of the machine 10. The control system 25 may include an electronic control module or controller 26 and a plurality of sensors associated with the machine 10. The term “sensor” is meant to be used in its broadest sense to include one or more sensors and related components that may be associated with the machine 10 and that may cooperate to sense various functions, operations, and operating characteristics of the machine.

The controller 26 may be an electronic controller that operates in a logical fashion to perform operations, execute control algorithms, store and retrieve data and other desired operations. The controller 26 may include or access memory, secondary storage devices, processors, and any other components for running an application. The memory and secondary storage devices may be in the form of read-only memory (ROM) or random access memory (RAM) or integrated circuitry that is accessible by the controller. Various other circuits may be associated with the controller 26 such as power supply circuitry, signal conditioning circuitry, driver circuitry, and other types of circuitry.

The controller 26 may be a single controller or may include more than one controller disposed to control various functions and/or features of the machine 10. The term “controller” is meant to be used in its broadest sense to include one or more controllers and/or microprocessors that may be associated with the machine 10 and that may cooperate in controlling various functions and operations of the machine. The functionality of the controller 26 may be implemented in hardware and/or software without regard to the functionality. The controller 26 may rely on one or more data maps relating to the operating conditions of the machine 10 that may be stored in the memory of controller. Each of these data maps may include a collection of data in the form of tables, graphs, and/or equations.

Controller 26 may be in communication with drive system 13 and operator interface 17 and may be configured to control operation of drive system 13 in response to signals received from the operator via operator interface 17. Communications between controller 26 and the other components of machine 10 may be facilitated by communication links and other suitable network architecture.

Referring to FIG. 2, drive system 13 may include components that cooperate to generate and transmit power to fraction devices 15 in response to commands from controller 26. In particular, drive system 13 may include a prime mover 30 configured to generate a power output, and a transmission system 31 operatively coupled thereto to receive, convert, and/or transmit the power output in a useful manner to drive traction devices 15.

Prime mover 30 may be an internal combustion engine or any other type of power source. Prime mover may have multiple subsystems (not shown) that cooperate to produce power output. The subsystems may include, for example, a fuel system, an air induction system, an exhaust system, a lubrication system, a cooling system, and any other appropriate system. Controller 26 may be configured to regulate the operation of any one or more of the subsystems of prime mover 30.

An output speed sensor 32 may be associated with prime mover 30 to sense the output speed thereof. Output speed sensor 32 may embody any type of sensor. In one embodiment, the output speed sensor 32 may be mounted on a rotating component of prime mover 30, such as a crankshaft, flywheel, or the like. Signals produced by output speed sensor 32 may be processed by controller 26 to determine the speed of the prime mover such as the rotations per minute and used of other purposes as desired.

Transmission system 31 may function as a continuously variable hydrostatic transmission having an infinite number of available torque-to-speed output ratios (i.e., virtual gears) within its continuous overall range. Transmission system 31 may include at least one pump 34 operatively coupled to receive the output of prime mover 30. Two pumps are depicted in FIG. 2 with each pump being operatively hydraulically connected to power a motor 35 via a first hydraulic line 37 and second hydraulic line 38. Motor 35 may be driven by pressurized hydraulic fluid from pump 34 to rotate traction devices 15 and propel machine 10. Motor 35 may be directly connected to traction devices 15 to propel the machine 10. As described in more detail below, one or more operational characteristics of pump 34 and/or motor 35 may be directly regulated by controller 26.

Each pump 34 may be a variable displacement pump with the displacement controlled by controller 26. In one embodiment, signals from controller 26 may be used to control or adjust the displacement of the pumps 34. Each pump 34 may direct pressurized hydraulic fluid to and from one of the motors 35 in two different directions to operate the motors in forward and reverse directions. Each pump 34 may include a stroke-adjusting mechanism, for example a swashplate, the position of which is hydro- or electro-mechanically adjusted to vary the output (e.g., a discharge pressure or rate) of the pump. The displacement of each pump 34 may be adjusted from a zero displacement position, at which substantially no fluid is discharged from pump 34, to a maximum displacement position, at which fluid is discharged from the pump at a maximum rate. The displacement of each pump 34 may be adjusted so the flow is either into first hydraulic line 37 or into second hydraulic line 37 so that the pump 34 may drive motor 35 in both forward and reverse directions, depending on the direction of fluid flow. The pumps 34 may be operatively connected to prime mover 30 of machine 10 by, for example, a shaft, a belt, or in any other suitable manner.

Each motor 35 may be driven to rotate by a fluid pressure differential generated by a pump 34 and supplied through first hydraulic line 37 and second hydraulic line 38. Specifically, motor 35 may include first and second chambers (not shown) located on opposite sides of a pumping mechanism such as an impeller, plunger, or series of pistons (not shown). When the first chamber is filled with pressurized fluid from pump 34 via first hydraulic line 37 and the second chamber is drained of fluid returning to pump 34 via second hydraulic line 38, the pumping mechanism may be urged to move or rotate in a first direction (e.g., in a forward traveling direction). Conversely, when the first chamber is drained of fluid and the second chamber is filled with pressurized fluid, the pumping mechanism may be urged to move or rotate in an opposite direction (e.g., in a rearward traveling direction). The flow rate of fluid into and out of the first and second chambers may determine an output velocity of motor 35, while a pressure differential across the pumping mechanism may determine an output torque.

In one embodiment, each motor 35 may be a fixed, multi-speed motor. In such case, the motor 35 has a finite number of configurations or displacements (e.g., two) between which the motor may be shifted. The motor 35 may thus operate as a fixed displacement motor with a plurality of distinct displacements. For example, a two-speed motor will thus have a first displacement and a second displacement so that the motor has two operating speeds and torque ranges. As depicted in FIG. 2, each motor 35 may be shifted between the different displacements (and thus speeds) by adjusting hydraulic valves 39 that are controlled by controller 26 and operatively connected to the motor. Other manners of shifting the motor 35 are contemplated. In some instances, a variable displacement motor may be used.

In some embodiments, motor 35 may also operate to create a pressure differential within transmission system 31 that functions to slow machine 10 and/or recover energy during deceleration of machine 10. In particular, there may be times when traction devices 15 rotate at a faster speed and/or with greater torque than motor 35 would otherwise be driven by fluid from pump 34. In this situation, motor 35 may function as a pump, pressurizing fluid directed back to pump 34, which may function as a motor in this situation. When motor 35 pressurizes fluid, energy imparted to motor 35 by traction devices 15 may be dissipated, thereby slowing the rotation of traction devices 15. The pressurized fluid directed from motor 35 back to pump 34 may reduce the load placed on prime mover 30 by pump 34 and, in some situations, even be used to drive prime mover 30.

Machine 10 may also be equipped with a braking device such as services brakes (not shown). The braking device may be operatively associated with one or more of the traction devices 15 of machine 10 and may be configured to retard the motion of machine 10 when commanded to do so by controller 26 (e.g., in response to a braking signal received via brake input 21). In one embodiment, the braking device may include a hydraulic pressure-actuated mechanism such as, for example, a disk brake or a drum brake that is disposed adjacent a wheel of traction device 15.

In some instances, pressing the brake input 21 may merely reduce the input command to the pump 34 to reduce the speed of machine 10. In other instances, such as, for example, when rapid deceleration is desired, pressing the brake input 21 may also result in the application of the braking device.

A motor speed sensor 40 may be operatively associated with each motor 35 to determine the rotational speed of the motors. Controller 26 may utilize the speed of the motors 35 to determine the travel speed of machine 10. In other instances, the travel speed of machine 10 may be determined by other mechanisms, such as a GPS device.

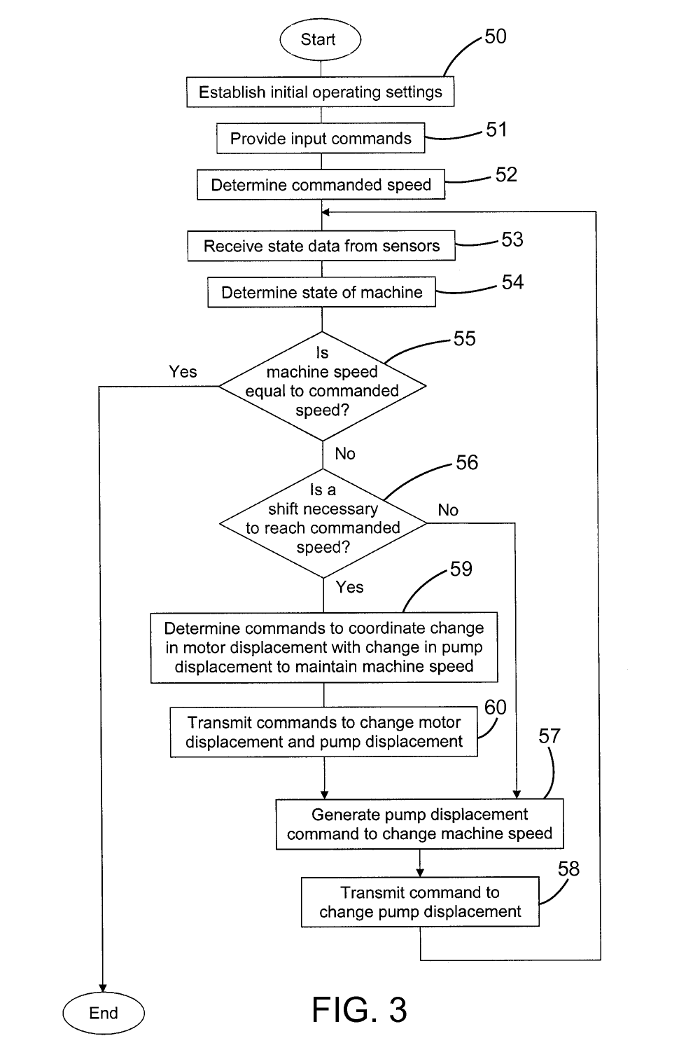

Referring to FIG. 3, a flowchart is depicted of the operation of the drive system 13. At stage 50, an operator may establish initial operating settings for machine 10 such as by controlling the transmission input 22 and the speed input 23. The operator may use the transmission input 22 to select a virtual gear in which the machine will operate. For example, the operator may choose to operate the machine 10 in a virtual first gear with the highest torque output range and a corresponding lowest travel speed range. In other instances, the transmission input 22 may be utilized to select transmission operation in which the drive system 13 operates initially in a virtual first gear and subsequently shifts to a virtual second gear to maximize the efficiency and performance of the machine 10. If desired, the machine may operate in this mode by default.

An operator may use speed input 23 to select a maximum travel speed of the machine. It may be desirable to set the maximum travel speed command to be less than the maximum possible travel speed of the machine. This may be desirable, for example, in instances in which an operator knows that an operation of the machine 10 is best performed at a particular speed. In such case, the operator may set the maximum travel speed command equal to the desired speed for the operation. This permits the operator to maintain the throttle input 20 at its maximum displacement to maintain the machine at the desired travel speed. The speed input 23 may include pre-set buttons or other input devices.

At stage 51, the operator may provide input commands in the form of displacing the throttle input 20 and displacing the brake input 21. By moving the throttle input 20, the operator may generate a throttle input command that is indicative of the desired travel speed and direction of the machine 10. Similarly, movement of the brake input 21 may generate a brake input command that is indicative of a desired deceleration or reduction in acceleration of the machine 10. The throttle signals from the throttle input 20 and brake signals from brake input 21 may be received by controller 26 and utilized to determine the desired commanded travel speed of the machine 10 at stage 52. To do so, the controller 26 may utilize a data map to determine the desired or commanded speed based upon the displacements of the throttle input 20 and the brake input 21.

At stage 53, the controller 26 may receive state data from sensors associated with machine 10. The controller 26 may use the state data at stage 54 to determine the state of the machine 10. For example, controller 26 may receive output speed data from the output speed sensor 32 that is indicative of the output speed of the prime mover 30. In some instances, the controller 26 may utilize the output speed data to determine the revolutions per minute of the prime mover. In another example, controller 26 may also receive data from a motor speed sensor 40 associated with each motor 35 and the controller may use the motor speed data to determine the speed and direction of rotation of the motors.

In one embodiment, the displacement of pumps 34 may be determined based upon the electrical signals used to control the stroke-adjusting mechanism. For example, during assembly or set-up, signals may be sent to the pump and the position of the stroke-adjusting mechanism noted and the signal and displacement recorded to establish a data map that correlates the electrical signal with the displacement of the pump. More specifically, during the assembly or set-up process, the signals may be noted when the pump is at the zero displacement position and each of the maximum displacement positions. In addition, intermediate positions may also be established as part of the data map. With such a set-up process, the pump 34 does not need a dedicated sensor for monitoring its displacement but rather controller 26 may utilize the electrical signals used to control the pump to determine the displacement. In an alternate configuration, a pump displacement sensor may be associated with each pump 34.

The displacement or position of motor 35 may be determined based upon the signals controlling by the motor sent by controller 26. During assembly or set-up, signals may be provided that are sufficient to position the motor 35 in its first position and its second position and the signals recorded as part of the data map. More specifically, signals may be recorded to shift hydraulic valves 39 to change the flow of hydraulic fluid to the motor 35 through the valves to shift the motor 35 between its first and second positions.

If desired, controller 26 may utilize the motor speed to also determine the speed of the machine 10 relative to a ground reference. In the alternative, other manners of determining machine travel speed may be utilized, such as through the use of a GPS device.

At decision stage 55, controller 26 may determine whether the machine is operating at the commanded or desired travel speed. To do so, the controller 26 may compare the commanded speed to the travel speed of the machine 10 as determined from the motor speed. If the machine 10 is operating at the commanded speed, no additional changes to the engine speed, displacement of the pump 34, or speed of the motor 35 are necessary.

If the machine is not operating at the commanded speed, the controller 26 may determine at decision stage 56 whether a shift in the displacement of the motor 35 is necessary to reach the commanded speed. Controller 26 may include a data map that correlates commanded speeds with the current travel speed of the machine 10, displacement of pump 34, and the speed and displacement of the motor 35. As a result, based upon the commanded speed determined at stage 52 and the state of the machine 10 as determined at stage 54, the controller 26 may determine whether a shift is necessary to reach the commanded speed.

If no shift is necessary, the controller may generate at stage 57 a pump displacement command to change the displacement of the pump 34. The pump displacement command may be transmitted at stage 58 to change the pump displacement. The change in pump displacement will change the flow rate within first hydraulic line 37 and second hydraulic line 38 which will result in a change (either an increase or a decrease) in the motor speed to change the travel speed of the machine 10 (either an increase or a decrease) towards the commanded speed. The controller 26 may repeatedly perform steps 53-58 until either the machine 10 is traveling at the commanded speed at stage 55 or a shift in the displacement of motor 35 is necessary at decision stage 56.

If a shift in the displacement of the motor 35 is necessary at decision stage 56, the controller 26 may determine at stage 59 the commands necessary to coordinate the shift in motor displacement and a change in the pump displacement in order to closely maintain the current travel speed of the machine 10. In other words, the controller 26 operates to reduce or eliminate any acceleration or deceleration of the machine 10 while changing the motor displacement. This may be desirable in some operations to increase the performance and/or efficiency of the operation of the machine. For example, when operating a compactor, a rapid or abrupt change in speed of the traction devices 15 may result in degradation of the finished surface or mat upon which the machine is operating. As a result, the finished surface may require re-working to repair the damage caused by the change in speed of the wheels.

It should be noted that the motor 35 has a finite number of fixed displacements and thus a shift in displacement of the motor may change its rotational speed. If the motor 35 is directly coupled to the fraction devices 15, a rapid or abrupt change in the travel speed of the machine may occur upon shifting the displacement of the motor. Accordingly, controller 26 may be configured to coordinate the changes in displacements of the pump 34 and the motor 35.

To coordinate the changes in displacement of the pump 34 and the motor 35, the controller 26 may control the magnitude of the change in the pump displacement as well as the timing of the changes in pump displacement and motor displacement to maintain the output speed of the motor 35 and thus the travel speed of the machine 10. For example, when an up-shifting to increase the potential top speed of the machine 10 (i.e., decreasing the displacement of the motor 35) the controller 26 may be configured to reduce the displacement of the pump 34 before reducing the displacement of the motor to reduce the pressure of the hydraulic fluid (within either the first hydraulic line 37 or second hydraulic line 38) that is driving the motor. This reduction in pressure is desirable as the reduction in displacement of the motor 35 may otherwise cause a rapid increase in the rotational speed of the motor. It should be noted that due to lag times in the responses of the components within the hydraulic system, the reduction in displacement of the pump 34 may be timed so that the reduction does not materially affect the rotational speed of the motor 35.

Similarly, when down-shifting to decrease the potential top speed of the machine 10 and increase the potential torque, the displacement of the motor 35 will be increased. In such case, without the desired coordination of the changes to the displacement of the pump 34 and the motor 35, the hydraulic pressure at the motor 35 may decrease and result in a rapid decrease in the rotational speed of the motor. Accordingly, the controller 26 may delay shifting the motor 35 to its increased displacement while increasing the displacement of the pump 34. The increase in displacement of the pump 34 will temporarily increase the pressure within the hydraulic system to compensate for the increase in displacement of the motor 35 and thus reduce that impact of the change in motor displacement on the rotational speed of the motor.

It should be noted that the timing of the changes in the displacements of the pump 34 and the motor 35 may be dependent upon the types of components used in the transmission system. For example, the responsiveness of the pump 34 and motor 35 may depend upon the configuration, size, and even the manufacturer of the components. In addition, the diameter and length of the hydraulic lines may also affect the responsiveness of the components and thus the required timing to create a smooth shifting process. Still further, the temperature and viscosity of the hydraulic fluid may also be factors upon which the timing may be dependent. The engine speed of the prime mover is also a variable that impacts the operation of the pump 34 and thus the shifting of transmission system 31. However, it may be undesirable to vary the engine speed as part of the shifting process if the prime mover is powering other systems in addition to the drive system 13. Regardless, the timing of the changes in displacements of the pump 34 and the motor 35 may also be dependent on the engine speed. Each of the factors that may affect the timing of the changes in displacement and thus the shifting process may be accounted for in a data map within controller 26.

The amount of acceleration or deceleration that may be acceptable for a particular drive system 13 may depend on the type of machine 10 being operated and the type of operation being performed. Accordingly, as used herein, maintaining the travel speed of the machine 10 is not absolute but rather relatively small amounts of change in travel speed are to be expected. For example, when operating a compactor on asphalt, a change in speed of less than ±0.25 kilometers per hour may be considered maintaining the travel speed of the machine. In another example, such as when operating a loader, a greater change in speed may be considered maintaining the travel speed of the machine. It is contemplated that other values and ranges of acceleration and deceleration may be considered acceptable depending on the type of machine and operation involved.

### INDUSTRIAL APPLICABILITY

The disclosed drive system may be applicable to any machine having a hydrostatic transmission system. The disclosed drive system includes a variable displacement pump 34 and a motor 35 that is changeable between a first displacement and a second displacement. Controller 26 may coordinate the amount and timing of changes in the displacement of the pump 34 with a shift in the displacement of the motor 35 to reduce or eliminate any rapid or abrupt momentary acceleration or deceleration of the motor that may occur when shifting the motor between the first and second displacements. With transmission system 31, machine 10 may maximize the efficiency of its operation by selection of desired gear ratios and shift points without rapid or abrupt changes in the rotational speed of the motor 35.

The drive system further includes a prime mover 30 with the pump 34 being driven by the prime mover. The motor 35 may be hydraulically connected to and driven by the pump 34. The controller 26 may be configured to determine a travel speed of the machine 10 and determine a motor displacement command to shift the motor 35 from the first motor displacement to the second motor displacement. The controller 26 may be further configured to determine a pump displacement command to change the displacement of the pump 34 and coordinate transmittal of the pump displacement command and the motor displacement command to maintain the travel speed of the machine while changing the displacement of the pump 34 and shifting the motor 35 from the first motor displacement to the second motor displacement.

It will be apparent to those skilled in the art that various modifications and variations can be made to the disclosed drive system. Other embodiments will be apparent to those skilled in the art from consideration of the specification and practice of the disclosed drive system. It is intended that the specification and examples be considered as exemplary only, with a true scope being indicated by the following claims and their equivalents.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A drive system for a machine, comprising:
a prime mover;
a pump driven by the prime mover, the pump having a continuously variable displacement;
a motor hydraulically driven by the pump, the motor having a changeable displacement between a first motor displacement and a second motor displacement; and
a controller configured to:
determine a travel speed of the machine;
determine a motor displacement command to shift the motor from the first motor displacement to the second motor displacement;
determine a pump displacement command to change a displacement of the pump; and
coordinate transmittal of the pump displacement command and the motor displacement command to maintain the travel speed of the machine while changing the displacement of the pump and shifting the motor from the first motor displacement to the second motor displacement.

2. The drive system of claim 1, wherein the controller is further configured to determine a magnitude of the pump displacement command and a timing of the pump displacement command relative to the motor displacement command.

3. The drive system of claim 2, wherein the pump displacement command occurs prior to the motor displacement command.

4. The drive system of claim 2, wherein the pump displacement command occurs after the motor displacement command.

5. The drive system of claim 1, wherein the controller is further configured to determine a speed of the prime mover, and a magnitude of the pump displacement command and a timing of the pump displacement command are based upon the speed of the prime mover.

6. The drive system of claim 1, wherein the changeable displacement of the motor permits only two configurations of the motor.

7. The drive system of claim 1, wherein the changeable displacement of the motor permits a finite number of configurations of the motor.

8. The drive system of claim 1, further including a throttle input movable by an operator to generate a throttle input command to indicate a desired travel speed of the machine.

9. The drive system of claim 8, wherein the controller is further configured to determine whether a shift of the motor from the first motor displacement to the second motor displacement is required to reach the desired travel speed of the machine.

10. The drive system of claim 8, further including a speed input movable by an operator to select a maximum allowable speed of the machine and wherein the throttle input indicates the desired travel speed of the machine as a function of the maximum allowable speed of the machine.

11. The drive system of claim 8, wherein the throttle input is also movable by the operator to indicate a desired travel direction.

12. The drive system of claim 11, wherein the throttle input is a joystick pivotable from a neutral position toward a maximum displaced position in a first direction to indicate the desired travel speed of the machine during travel in a forward direction, and from the neutral position toward a maximum displaced position in a second direction to indicate the desired travel speed of the machine during travel in a reverse direction.

13. The drive system of claim 1, further including a brake input movable by an operator to indicate a desire to decelerate the machine.

14. A controller-implemented method of driving a machine, comprising:
determining a travel speed of the machine;
driving a continuously variable displacement pump with a prime mover;
determining a pump displacement command to change a displacement of the pump;
hydraulically driving a fixed displacement multi-speed motor with the pump;
determining a motor displacement command to shift the motor from a first motor displacement to a second motor displacement; and
coordinating transmittal of the pump displacement command and the motor displacement command to maintain the travel speed of the machine while changing the displacement of the pump and shifting the motor from the first motor displacement to the second motor displacement.

15. The method of claim 14, further including determining a magnitude of the pump displacement command and a timing of the pump displacement command relative to the motor displacement command.

16. The method of claim 15, wherein the pump displacement command occurs prior to the motor displacement command.

17. The method of claim 15, wherein the pump displacement command occurs after the motor displacement command.

18. The method of claim 14, further including moving a throttle input to generate a throttle input command to indicate a desired travel speed of the machine, determining a speed of the prime mover, and determining a magnitude of the pump displacement command and a timing of the pump displacement command based upon the speed of the prime mover.

19. The method of claim 18, further including determining whether a shift of the motor from the first motor displacement to the second motor displacement is required to reach the desired travel speed of the machine.

20. A machine, comprising:
a prime mover;
a pump driven by the prime mover, the pump having a continuously variable displacement;
a motor hydraulically driven by the pump, the motor having a changeable displacement between a first motor displacement and a second motor displacement;
a plurality of traction devices operatively driven by the motor; and
a controller configured to:
determine a travel speed of the machine;
determine a motor displacement command to shift the motor from the first motor displacement to the second motor displacement;
determine a pump displacement command to change the displacement of the pump; and
coordinate transmittal of the pump displacement command and the motor displacement command to maintain the travel speed of the machine while changing a displacement of the pump and shifting the motor from the first motor displacement to the second motor displacement.
